(19) United States
(12) Patent Application Publication
(10) Pub. No.: US 2022/0084149 A1
(43) Pub. Date: Mar. 17, 2022

(54) SYSTEM AND METHOD FOR PROVIDING A USER JOURNEY FOR A PATENT SALES AND OWNERSHIP PLATFORM

(71) Applicant: Erich Lawson Spangenberg, Paris (FR)

(72) Inventor: Erich Lawson Spangenberg, Paris (FR)

(21) Appl. No.: 17/343,172

(22) Filed: Jun. 9, 2021

Related U.S. Application Data
(60) Provisional application No. 63/036,888, filed on Jun. 9, 2020.

(51) Int. Cl. G06Q 50/18

(52) U.S. Cl. CPC G06Q 50/184; G06Q 50/188

(57) ABSTRACT

The objective of the present invention is to establish the Steps (major levels of interaction) and Elements (interactions within each Step level) for a Patent Owner that may engage with the platform as a seller of patents. The elements and implicated functionality of the present invention includes user registration, pre and post-registration platform interaction, listing patents for sale, buyer engagement, negotiation of the sale and contract execution.

### PRIORITY CLAIMS

This application claims the benefit of U.S. Provisional Application Ser. No. 63/036,888, filed Jun. 9, 2020, the contents of which are incorporated herein.

### BACKGROUND OF THE INVENTION

The field of the invention is related to patent sales transactions between the patent owner/seller and patent buyer.

### SUMMARY OF THE INVENTION

The objective of the present invention is to establish the Steps (major levels of interaction) and Elements (interactions within each Step level) for a Patent Owner that may engage with the Platform as a seller of patents.

Key terms used in this User Journey are defined for the benefit of the reader.

“Ambassador” is a third party that acts to promote the Platform and is often a law firm or other IP professional that is compensated with respect to specific Owning Entities referred by the Ambassador. Ambassador activity will be traced through the Platform in R2.

“Analytics I (A-1)” is a free set of analytic tools available for free to all Users.

“Analytics II (A-2)” is a set of analytic tools (which includes A-1) available to Owner Representatives (OR) and Buyer Representatives (BR). You access A-2 simply by being Registered.

“Analytics III (A-3)” is a set of analytic tools (which includes A-1 and A-2) only available (i) on a pay per inquiry or subscription basis or (ii) to some preferred set of Users (e.g., Owner Representatives (OR) or Buyer Representatives (BR) that engage in some desired Platform behavior).

“Assignee” is another name for the Owning Entity (OE) while they are the owner. Once there is a Buying Entity (BE) and title transfers, the “Assignee” becomes the “Assignor” and the Buying Entity (BE) becomes the “Assignee.” Often the first “owner” of a patent is the inventor who then “assigns” title to their corporate employer.

“Assignor” is another name for the Owning Entity (OE) while they are the owner and after there is a Buying Entity (BE) that is taking assignment of title from the OE. An owner (assignor) assigns title to a buyer (assignee).

“Authority” is the process by which and confirmation that an Owner Representative (OR) or Buyer Representative (BR) in fact has authority to act on behalf of an Owning Entity (OE) or Buying Entity (BE).

“Buying Entity (BE)” is the patent buyer—typically a company that wants to acquire and own the Subject Patents—also called the “assignee” once they become the buyer. Most often this is a single entity.

“Buyer Representative (BR)” is the person (User) actually interacting with the Platform on behalf of the Buying Entity (BE)—they only become a “Buyer Representative” once the Identity and Authority are confirmed. The BR controls all of the engagements between the BE and the Platform, including authorizing other employees and agents to the OR to take actions on the Platform. This is a very important role.

“Identity” is the process by which and confirmation that the Buyer Entity (BE), Buyer Representative (BR), Owner Entity (OE) and Owner Representative (OR) are in fact who they claim to be.

“Listing” is a patent sale opportunity that has completed all Steps necessary for there to be a listing on the Platform.

“Origination” is the how a User comes to the Platform. The type of origination may change over time and including search, word of mouth or through an Ambassador or a returning User.

“Owning Entity (OE)” is the patent owner seller—typically the company, university, lab or individual that owns the patents—also called the “assignee” (when they are still the owner) and the assignor (once they sell) by patent people. Most often this is a single entity.

“Owner Representative (OR)” is the person actually interacting with the Platform on behalf of the Owning Entity—they only become an “Owner Representative” once the Identity and Authority are confirmed and Registration is completed. The OR controls all of the engagements between the OE and Platform, including authorizing other employees and agents to the OR to take actions on the Platform. This is a very important role.

“Platform” is the IPwe Platform and is accessed through www.lpwe.com. The Platform encompasses analytics, offer generation/review, diligence, contact administration, payment, reporting, third party service offerings and any other features offered, excluding marketing and pre-registration functionality.

“Potential Buyer Representative” is a User that has completed some but not all of the Registration process.

“Potential Owner Representative” is User that has completed some but not all of the Registration process.

“Registration” is the process by which a Buying Entity (and its Buyer Representative) and Owning Entity (and its Owner Representative) completes the Platform registration process that includes various functionality to confirm Identity and Authority.

“Registered Owner (RO)” is an Owning Entity (OE) that has completed Registration

“Subject Patents” is one or more patents an OE has identified it wished to sell.

“User” is anyone using the Platform in any capacity and includes a Buyer Representative and an Owner Representative.

The information contained in this Patent Owner (Seller) Journey is to provide a detailed user journey that will be used in the current and future design and development of the Platform. Other Journey documents will be implicated (and referred to). This project is not static and will regularly be revised as User interactions are better understood and additional functionality is developed.

The origination of how the Potential Owner Representative (POR) is introduced to the platform of the present invention can be through performing an internet search or a referral through a platform ambassador. Pre-Registration platform interaction includes features the POR can use on the platform prior to registration.

A POR becomes an Owner Representative (OR) through platform registration. This includes identification of a new owning entity (OE) by setting up an account and providing required information such as the OE name and contact email. The OR is then granted the authority to transact on the platform and control of OE and additional OR appointment and access to platform features.

Post-registration, platform interaction features available to the OR include the option to create a sale listing or license listing. Once registration is completed, the OR will get access to portfolio analytics data. The OE can enter into a listing contract with the platform for all sales listings.

In the preferred embodiment of the present invention, OR and OE lists patents for sale on the platform. The listing process includes identification of subject patents available for sale (Subject Patents) by OR through verification. The OR verification process is a dashboard type report that shows data such as the assignee and related patents, etc.

The terms of the listing are set by the OR and included in the contract. Terms include disclosure rules (what users see on platform) for disclosed data including patents, the technology area and OE information. Another listing term is a sale agreement between the OE and the platform.

The platform of the present invention utilizes a Deal Room feature, which is an electronic data room that facilitates communications, record keeping and transactions. Access to the deal room is designated by POR. Sale agreements and disclosure schedules can also be accessed in the deal room. The OE takes steps to upload patent(s) available for sale (Subject Patents) using a patent verification process.

Once the listing is live, other permitted users (depending on the terms of OE listing) can see Listing. Listing information is distributed to platform's demand side team electronically. Listing reporting is facilitated through electronic engagement via a dashboard and updated metrics reports. Security levels can be enabled for listing content based on listing preferences.

On the buying end, the Buyer Representative (BR) and Buying Entity (BE) must also complete a platform registration process similar to that of the OR and OE. The BR and BE must go through a buyer qualification process based on buyer balance sheet data. The BR has to register on the platform in order to see and/or make offers on listings and access analytics data.

Engagement between the BR and OR through the platform of the present invention is also known as the diligence and negotiation phase. The platform provides the OR and OE with the BR and BE track record and verification checks collected during registration. Once communication between the OR and the BR has been authorized, a communications channel is opened in the deal room.

Communication between all parties in the deal room requires that an NDA is executed between the BE and the OE. This NDA can be a form provided by either the OE or the BE, or it can be a standard form. Once the NDA has been executed, the BR is granted access to transaction room. The level of access to the transaction room can be controlled by the POR.

In order to start the contract phase of the patent seller and buyer user journey, the BR has completed or is far enough along in DD that OR and BR agree to commence contract negotiations. The contract can be a standard form agreement, or an agreement provided by the OE. The parties can iterate and/or negotiate on the contract with the Smart Contract support feature of the platform. The contract phase can be monitored and reported using the dashboard feature of the platform. The dashboard includes in-force contract tracking, royalty payment tracking, and other contract related features. Payment to complete the sale can be facilitated as a wire transaction using the platform and recorded on a blockchain.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an overview of the process flow of the present invention.

FIG. 2A is a flow diagram of the seller user journey pre-registration, registration and post-registration process of the present invention.

FIG. 2B is a flow diagram of the seller user journey marketplace process of the present invention.

FIG. 2C is a flow diagram of the seller user journey deal rooms, contracts, and payments process of the present invention.

FIG. 3A is a flow diagram of the buyer user journey pre-registration, registration and post-registration process of the present invention.

FIG. 3B is a flow diagram of the buyer user journey marketplace process of the present invention.

FIG. 3C is a flow diagram of the buyer user journey deal rooms, contracts, and payments process of the present invention.

### BRIEF DESCRIPTION OF THE APPENDIX

The appendix provides a summary chart of the patent market feature matrix of the present invention, and a chart of the patent seller element matrix based on an intended feature release schedule of the present invention.

### DETAILED DESCRIPTION OF THE PREFERRED EMBODIMENT

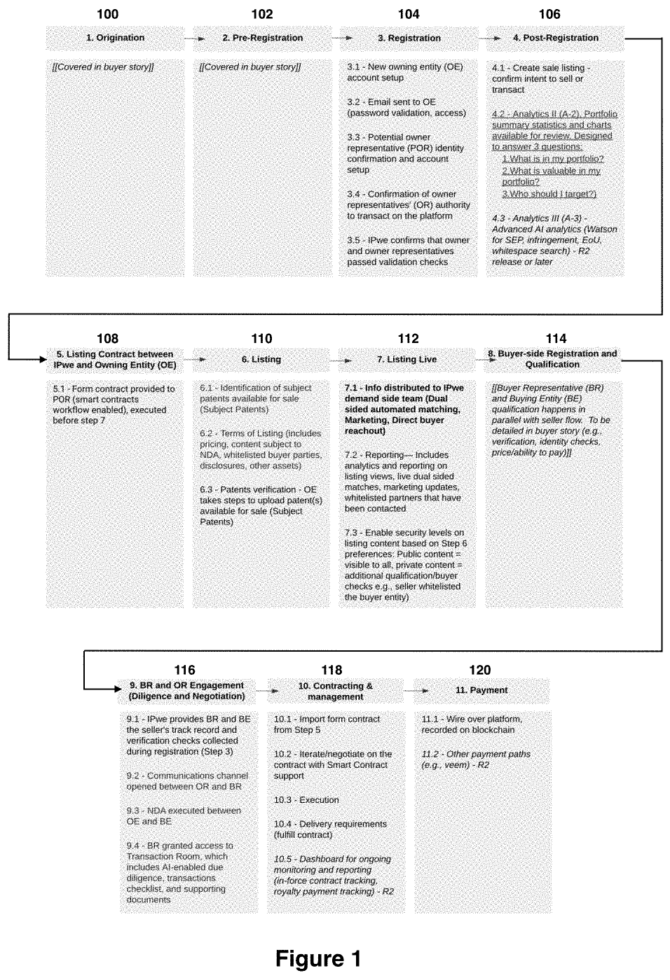

FIG. 1 is an overview of the process flow of the present invention. In accordance with the preferred embodiment of the present invention, the origination 100 of how the Potential Owner Representative (POR) is introduced to the platform of the present invention can be through performing an internet search or a referral through a platform ambassador. In one embodiment, the present invention can generate a metrics report, which is a simple dashboard management report that includes key data such as: the source of the POR; the number of the POR; the location of the POR; conversion to pre-registration platform interaction activities; and conversion to registrations.

Pre-Registration 102 platform interaction includes features the POR can use on the platform prior to registration. This can include platform features such as: analytics I (A-1); review marketing materials (e.g., videos, white papers, etc.); review process understanding materials (e.g., FAQs); bot engagement; contacting the platform administrator; and generating or viewing numbers via the metrics report feature.

A POR becomes an Owner Representative (OR) through platform registration 104. This includes identification of a new owning entity (OE) by setting up an account and providing required information such as the OE name and contact email. A confirmation email is then sent to the OE, whereby the OE can set a password, and basic access is granted to the POR. The POR must then complete the verification process through identity verification methods such as uploading an image of the POR's ID (e.g., passport or driver's license, and uploading a photo to confirm the POR's ID. The POR's identity is then confirmed and the platform administrator can establish the OE and POR credentials. The OR is then granted the authority to transact on the platform and control of OE and additional OR appointment and access to: analytics; transaction types (sale and license for R1); transaction limits (e.g., dollar amounts); duration (for re-verification parameters); and setting user rolls and permissions that include buying, selling and licensing. The platform administrator confirms that the OE and OR have successfully passed validation checks, and an updated metrics report can be generated.

Post-registration 106, platform interaction features available to the OR include the option to create a sale listing or license listing. Once Registration is completed, the OR will get access to Analytics II (A-2) data that include portfolio content analysis, portfolio valuation and sale target demographics. The OR can also access the optional Analytics III (A-3) data, such as the result of payment or reward for other desirable activity (e.g., Watson for SEP, infringement, EoU, whitespace search, etc.). The OR can also generate analytics data metrics reports.

The OE can enter into a listing contract 108 with the platform for all sales listings. This is a form contract provided to POR (may include a Concord or clause solution), and outline the OR's ability to comment and/or negotiate sales (if the OE is a large entity). The platform can flag small or large entities in the system. For small entities, execution and delivery is handled by the system only. For large entities, execution and delivery is handled by the system and the platform's legal team. The platform negotiator can change approval and execution of the listing. The platform can also implement Jira workflow for process and verification, and generate additional metrics reports for that data.

In the preferred embodiment of the present invention, OR and OE lists patents for sale on the platform 110. The listing process includes identification of subject patents available for sale (Subject Patents) by OR through verification. The OR verification process is a dashboard type report that shows data such as the assignee and related patents, etc. The OR verification process also requires the platform to match or confirm ownership, cross check patent office records, chain of title, clustering, etc., and may include a fraud and mistake filter. OR verification is then confirmed by the platform.

The terms of the listing are set by the OR and included in the contract. Terms include disclosure rules (what users see on platform) for disclosed data including patents, the technology area and OE information. If there is no disclosure, Company S (Seller) is on the platform but only will engage with qualified buyers (Company B), or Company B is on the platform but will only engage with qualified sellers (Company S). Potential sellers could say “if you bring me offers I will look” or Potential buyers could say “I am interested in buying, bring me sellers”. This can be considered the “Members Area” or “Board Area” feature of the platform. This feature may require an additional fee payment in a disclosed price range available under NDA upon request. Additional terms of the listing include options for non-exclusivity, and prohibited entities. The OR can also propose other unique terms for the listing. Another listing term is a sale agreement between the OE and the platform. This includes an OE verification step, disclosures, encumbrances, other information (such as claim charts, know how, etc.), other assets, and anything else the OE is selling with the subject patents (such as existing licenses).

The platform of the present invention utilizes a Deal Room feature, which is an electronic data room that facilitates communications, record keeping and transactions. Access to the deal room is designated by POR. The deal room feature includes: patents; standard diligence list (what has and has not been made available), a summary AI report and V score for each independent claim upon request; analytics reports (e.g., SEP match for SEP patents); third party vendors; claim charts; validity reports; reverse engineering; and legal reports. The deal room feature includes the option to request file histories of patents for an additional fee. The deal room feature can also include a form purchase agreement, white list (entities not licensed)/blacklist (entities licensed). Sale agreements and disclosure schedules can also be accessed in the deal room.

The OE takes steps to upload patent(s) available for sale (Subject Patents) using a patent verification process. This data can be uploaded using a standard excel form. An error report can be provided to POR where matching fails between the uploaded list and system confirmed list. This can be resolved through an electronic notification, however a final resolution may require human interaction. A metrics report can also be generated with this data.

Once the listing is live 112, other permitted Users (depending on the terms of OE listing) can see Listing. Listing information is distributed to platform's demand side team electronically. This information can include broker network data, patent matching data, and marketing team data. Marketing and advertising of the listing can be done online (e.g., with technical journals) and off platform efforts, with OE advertising on OE materials. The platform can include an OE page as an additional specialized marketing tool. Listing reporting is facilitated through electronic engagement via a dashboard and updated metrics reports. For example, if there has been no interest or low viewing numbers for the listing, the POR has the option to lower the listing price, amend the listing terms, or withdraw the listing. Security levels can be enabled for listing content based on listing preferences. Public content is visible to all, and private content requires additional qualification and/or buyer checks (e.g., seller whitelisted the buyer entity).

On the buying end, the Buyer Representative (BR) and Buying Entity (BE) must also complete a platform registration process 114 similar to that of the OR and OE. The BR and BE must go through a buyer qualification process based on buyer balance sheet data. The BR has to register on the platform in order to see and/or make offers on listings, access A-2 and A-3 data (with authority and access rules set by the POR), and view or generate metrics reports.

Engagement between the BR and OR 116 through the platform of the present invention is also known as the diligence and negotiation phase. The platform provides the OR and OE with the BR and BE track record and verification checks collected during registration. BE funds can be verified through prior transactions and the platform can create electronic reports on the BE that can be shared with the OR. These reports can include data such as past purchasing history and the supplier trust rating. The OR then approves the BE and authorizes the platform to make an introduction. The BR also approves the OE on their end and authorizes the platform to make introduction. Once communication between the OR and the BR has been authorized, a communications channel is opened in the deal room.

Communication and management 118 between all parties in the deal room requires that an NDA is executed between the BE and the OE. This NDA can be a form provided by either the OE or the BE, or it can be a standard form. Negotiation and execution of the NDA can disclose terms such as what the BR can see with or without an NDA with the OE. The OR can set communication rules through the platform using Confirmation and/or roll back functionality. Once the NDA has been executed, the BR is granted access to transaction room. The level of access to the transaction room can be controlled by the POR.

In order to start the contract phase of the patent seller and buyer user journey, the BR has completed or is far enough along in DD that OR and BR agree to commence contract negotiations. The contract can be a standard form agreement, or an agreement provided by the OE. The parties can iterate and/or negotiate on the contract with the Smart Contract support feature of the platform. The contract can include non-SC components (e.g., disclosure schedules). Execution of the contract incorporates jurisdictional legal issues and tax issues. Contact delivery requirements can be facilitated through global escrow accounts and can also include physical documents such as ribbon copies of purchased patents, inventor notebooks, etc. The contract phase can be monitored and reported using the dashboard feature of the platform. The dashboard includes in-force contract tracking, royalty payment tracking, and other contract related features.

Payment 120 to complete the sale can be facilitated as a wire transaction using the platform and recorded on a blockchain. Other payment paths can be incorporated, with consideration of tax implications (withholding), potential fraud, Veem, and escrow. Metrics reports of aggregated payment data can be generated. Additional payment parameters can include SC capabilities, and using specialized contract administrators through the platform that can perform future follow ups ranging from handling deliveries, to handling notices to default).

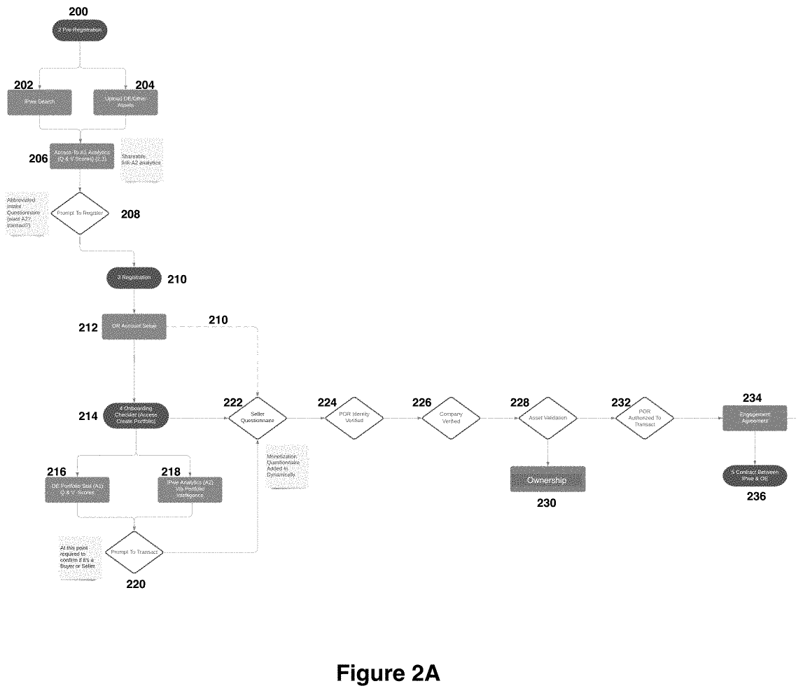

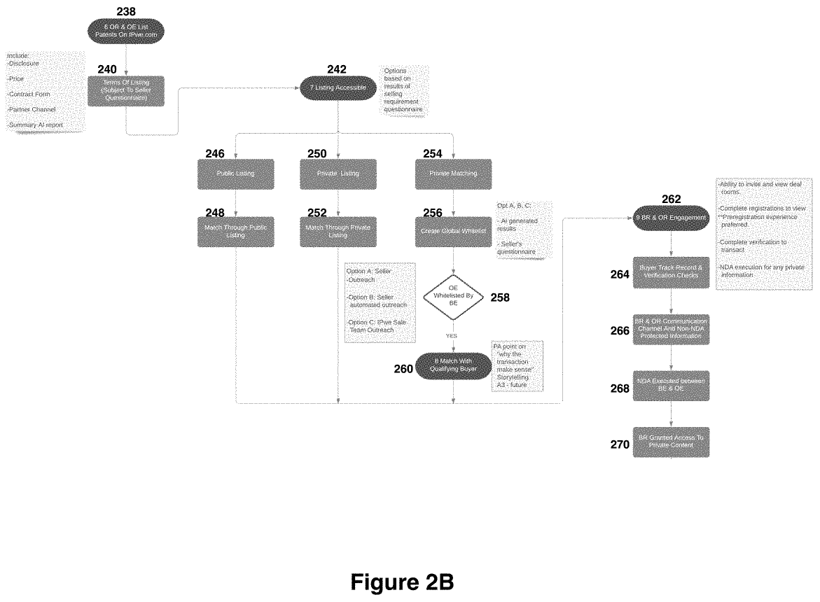

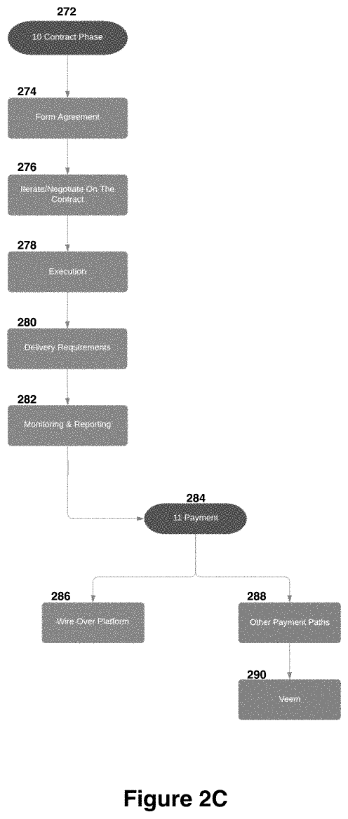

FIG. 2A is a flow diagram of the seller user journey pre-registration, registration and post-registration process of the present invention. The pre-registration process 200 includes access to the platform search feature 202 and allows for the user to upload OE data and other assets 204. The user has access to A-1 analytics 206 and is prompted to register 208. The registration process 210 requires the user to complete OR account setup 212. During the post-registration process, the user goes through the steps of the onboarding checklist, including access to create the portfolio 214. Portfolio access includes OE portfolio data (A-1) 216 and platform analytics data (A-2) via portfolio intelligence 218. The seller is prompted to transact 220 and at this point is required to confirm whether the user is a buyer or a seller. The user also has to complete the seller questionnaire 222 and verify POR identity 224. Once the POR company has been verified 226, assets are then validated 228 and ownership is processed 230, the POR is authorized to transact 232. In order to proceed to create a listing in the marketplace, the user must execute an engagement agreement 234 contract between the OE and the platform 236.

FIG. 2B is a flow diagram of the seller user journey marketplace process of the present invention. Once the user has completed the seller registration process 210, the OR and OE can list patents for sale on the platform 238. Terms of the listing 240, which are subject to the seller questionnaire, are: the disclosure the price; the contract form; the partner channel; and the summary AI report. Listing accessibility options 242 are then determined based on the results of the selling requirement questionnaire. If the listing is public 246, a buyer can be matched through the public listing 248 and the BR and OR can begin initial engagement 262. If the listing is private 250, a buyer can be matched through the private listing 252 through options such as: seller outreach; seller automated outreach; and platform sale team outreach. If the listing availability is selected as private matching 254, a global whitelist is created 256 (including AI generated results and the seller's questionnaire), and if the OE is whitelisted by the BE 258, then they are matched with the qualifying buyer 260. Once the listing is matched, the next step is BR and OR engagement 262. This includes the ability to invite and view deal rooms, complete the required registrations to view information, complete the verification to transact, and execute an NDA for disclosure of any private information between parties. The buyer must complete track record and verification checks 264 and a communication channel is opened up between the BR and OR 266. Once the NDA is executed by the BE and OE 268, the BR is granted access to any private content 270.

FIG. 2C is a flow diagram of the seller user journey deal rooms, contracts, and payments process of the present invention. Once the initial BR and OR engagement process 262 is complete, the parties enter into the contract phase 272. This includes providing a contract form agreement of the sale 274. The BR and OR can iterate and/or negotiate 276 on the contract before executing the contract 278. Delivery requirements 280 are met from the terms of the sale and the sale data is entered for monitoring and reporting 282 through the platform. Once the contract phase 272 is complete, the payment 284 of the sale can be transacted as a wire over the platform 286 or through other payment paths 288 such as Veem 290.

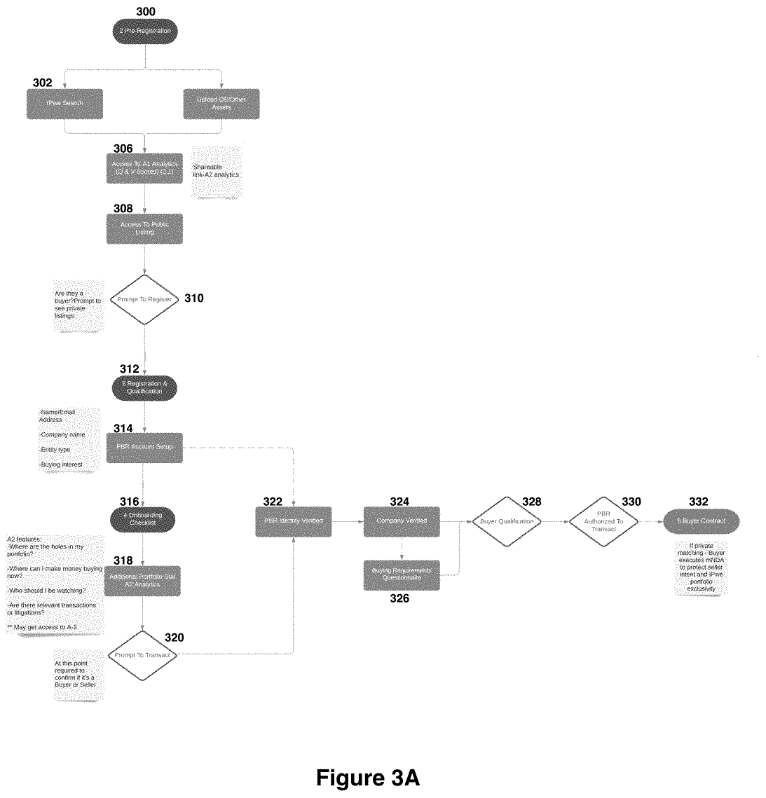

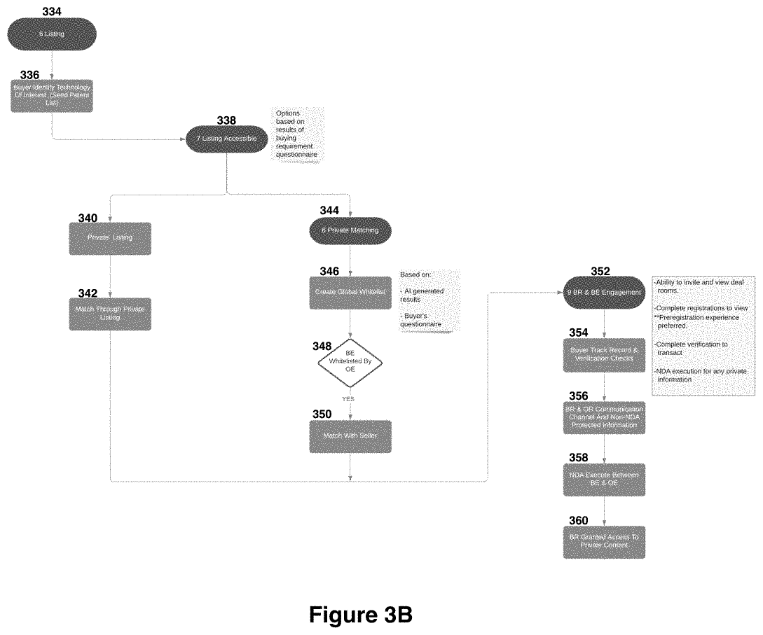

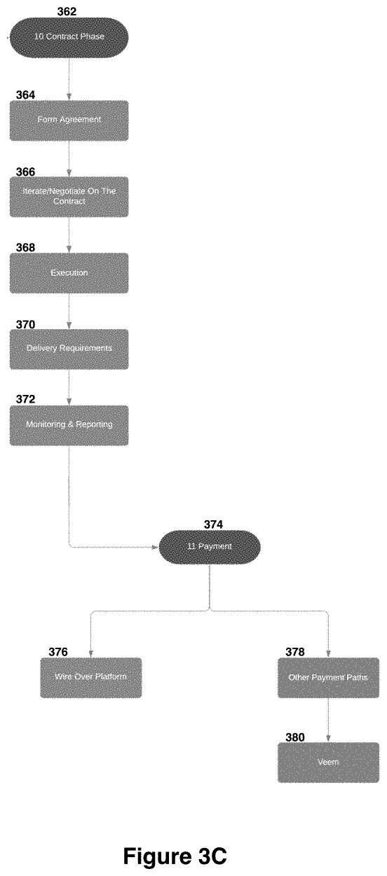

FIG. 3A is a flow diagram of the buyer user journey pre-registration, registration and post-registration process of the present invention. The pre-registration process 300 includes access to the platform search feature 302 and allows for the user to upload OE data and other assets 304. The user has access to A-1 analytics 306 and public listings 308 before being prompted to register 310. The registration and qualification process 312 requires for the user to complete PBR account setup 314, including providing information such as: the contact name and email address; company name; entity type; and buying interest. During the post-registration process, the user goes through the steps of the onboarding checklist 316, and access additional portfolio analytics data (A-2) 318 before being prompted to transact 320. In order to participate in transactions, PBR identity 322 and the company are verified 324, and an optional buyer requirements questionnaire 326 can be completed. Once the buyer has successfully met the transaction qualifications 328, the PBR is authorized to transact 330 and can provide a buyer contract 332, such as executing an NDA if electing to participate in private listing matching, in order to protect seller intent and platform exclusivity.

FIG. 3B is a flow diagram of the buyer user journey marketplace process of the present invention. Once the user has completed the buyer registration process 312, the buyer can access the marketplace listings 334. Listings can be narrowed down based what the buyer identifies as the technology of interest (or a seed patent list) 336. Listings are then accessible 338 and options are based on the results of the buying requirement questionnaire. Private listings 340 can be accessed if the buyer is matched by the platform 342. Private matching 344 can be done by creating a global whitelist 346. If the BE is whitelisted by the OE 348, then they are matched with the seller 350 and can proceed to BR and BE engagement 352. This includes the ability to invite and view deal rooms, complete the required registrations to view information, complete the verification to transact, and execute an NDA for disclosure of any private information between parties. The buyer must complete track record and verification checks 354 and a communication channel is opened up between the BR and OR 356. Once the NDA is executed by the BE and OE 358, the BR is granted access to any private content 360.

FIG. 3C is a flow diagram of the buyer user journey deal rooms, contracts, and payments process of the present invention. Once the initial BR and BE engagement process 352 is complete, the parties enter into the contract phase 362. This includes providing a contract form agreement of the sale 364. The BR and OR can iterate and/or negotiate on the contract 366 before executing the contract 368. Delivery requirements 370 are met from the terms of the sale and the sale data is entered for monitoring and reporting 372 through the platform. Once the contract phase is complete, the payment 374 of the sale can be transacted as a wire over the platform 376 or through other payment paths 378 such as Veem 380.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of.”

1. A system for providing a user journey information platform for conducting sales of patent asset sales comprising:
a database establishing the roles of parties to the transaction wherein said roles of transacting parties are defined for the benefit of any recipient of any user of said database;
establish one of said transacting parties to serve as an ambassador to promote said platform to be compensated with respect to patent transacting activity;
establish one of said transacting parties to be a patent assignor;
establish one of said transacting parties to be a patent assignee;
establishing a monitoring of said sales of patent assets for developing analytics available for users of said platform; and
establish a registration wherein said registration is a process by which said assignee associates with assignee representatives and wherein said assignee and assignee representatives transact said patent sales with said patent assignor.

2. (canceled)

3. A system according to claim 1 wherein said transacting parties are connected via a blockchain.

4. A system according to claim 3 wherein an Ethereum smart contract is provided to said transacting parties.

5. A system according to claim 1 wherein said registration is created via a blockchain transaction.

6. A system according to claim 5 wherein an Ethereum smart contract is used to create said registration.

7. A method for providing a user journey information platform for conducting sales of patent asset sales comprising:
establishing a database containing the roles of parties to the transaction wherein said roles of transacting parties are defined for the benefit of any recipient of any user of said database;
establishing that one of said transacting parties is to serve as an ambassador to promote said platform to be compensated with respect to patent transacting activity;
establishing one of said transacting parties to be a patent assignor;
establishing one of said transacting parties to be a patent assignee;
establishing a monitoring of said sales of patent assets for developing analytics available for users of said platform; and
establishing a registration wherein said registration is a process by which said assignee associates with assignee representatives and wherein said assignee and assignee representatives transact said patent sales with said patent assignor.

8. A method according to claim 7 wherein said transacting parties are connected via a blockchain.

9. A method according to claim 8 wherein an Ethereum smart contract is provided to said transacting parties.

10. A method according to claim 9 wherein said registration is created via a blockchain transaction.

11. A method according to claim 10 wherein an Ethereum smart contract is used to create said registration.
